(19) United States
(12) Patent Application Publication
(10) Pub. No.: US 2009/0010720 A1
(43) Pub. Date: Jan. 8, 2009

(54) Use of air activated gravity conveyors in a continuous particulate removal process from an ESP or baghouse

(75) Inventors: Louis S. Schwartz, Northampton, PA (US); William Beidleman, Bath, PA (US)

Correspondence Address: Daniel DeJoseph;F.L. Smidth Inc., 2040 Avenue C, Bethlehem, PA, 18017-2188, US

(73) Assignee: FLSmidth A/S

(21) Appl. No.: 11/825,060

(22) Filed: Jul. 2, 2007

(51) Int. Cl. B65G 53/50

(52) U.S. Cl. 406/144; 406/124

(57) ABSTRACT

Disclosed is a method for transporting particulate material produced in an industrial process from a particulate collection means, through an underlying hopper, and into an air activated gravity conveyor system that is sized to convey particulate material at a rate that is at least about three times the rate that such particulate material is produced in the industrial process.

### FIELD OF THE INVENTION

This invention relates to the continuous removal of particulate material from an electrostatic precipitator or baghouse system that in turn removes particulates from an industrial exhaust gas stream. The invention has particular relevance to the power plant industry but is not limited to use in that field.

### BACKGROUND OF THE INVENTION

The emission of particulates in industrial exhaust gas streams must be carefully controlled in light of federal, state, and local regulations designed to curtail pollution. As one example, fly ash is a fine particulate residue which is a by-product of the burning of powdered coal collected from the flue gas stream of power plants and other coal-burning installations, trash-to-energy facilities, steel mills, coke ovens, foundries, pulp and paper and co-generation plants. Ten percent ash content is not unusual in some bituminous coals, so, for example, a power plant burning 10,000 tons of this coal a day will typically produce 1,000 tons of ash, 800 tons of which is typically fly ash which is carried off in a flue gas stream and 200 tons is bottom ash. Larger power plants may produce more than 3000 tons of fly ash in a given day.

A utility power plant system typically comprises a boiler for burning coal to produce heat used to generate electricity. The boiler produces non-combustible materials that exit the boiler in the form of gases where they pass to an ash disengagement system that is coupled to the boiler that receives the gases exiting the boiler and separates and collects most of the ash contained within the gases. A fly ash transport system is coupled to the ash disengagement system for receiving the collected ash and transporting the collected ash to a remote storage vessel typically via a pneumatic conveying system.

The Clean Air Act (CAA) requires that facilities burning fuels that produce fly ash must remove over 99 percent of the particulate matter from the exhaust gas prior to its release into the atmosphere. The EPA can levy heavy fines for non-compliance as well as shut down facilities until corrective action takes place.

Generally, two methods are used to separate fly ash from flue gas. The more common in a typical power plant operation is an electrostatic precipitator (ESP), which consists of a charged grid that the flue gas passes through. As the flue gas passes through the grid, the fly ash particles become charged and adhere to collection electrodes. At a predetermined interval, an automatic hammer raps the electrodes, loosening the fly ash and allowing it to fall by gravity and collect in a hopper located underneath the ESP. The ash is removal from the hopper generally in a predetermined sequence. Failure to remove the ash in a timely manner can cause the ash to short out the electrostatic grid, allowing the fly ash to vent with the flue gas, resulting in a CAA compliance violation.

The second method of separating fly ash from flue gas is a bag house. This system consists of multiple bag house compartments, each containing an array of fabric bags that will be used to capture the fly ash as the flue gas passes through the filter bags. Periodically, each compartment will be cleaned by pulsing the bags to dislodge particulates into a fly ash hopper beneath the compartment. As with electrostatic precipitators, timely removal of fly ash is critical. If the level rises to a point where it reaches the filters, they become clogged and require a manual cleanout. The weight of the ash can damage the bags, causing tears and resulting in a noncompliant release of ash. Therefore, level measurement devices are necessary in hoppers used in both ESP and bag house applications to avoid non-compliance fines and unscheduled shut downs as well as to prevent costly repairs to precipitators and bag houses.

Power plants, for example, will employ a plurality of hoppers under an ESP(s) or fabric filter bags. Generally the hoppers will be automatically emptied sequentially. Typically the fly ash removed from the collection hopper is conveyed to a remote storage or disposal site by a pneumatic conveying system. The hoppers will employ a shut off valve having automatic controls that will open during the predetermined discharge time and will close after the hopper is emptied.

During the interval between when the hoppers are emptied, small amounts of fly ash will fall unimpeded from the ESP plates or bags into the underlying hopper. Collected fly ash, like other particulates, is a hot (>300° F.), dusty, abrasive material that is often sticky causing it to become cohesive and coat everything it contacts. If it is allowed to sit too long in a hopper it can plug or bridge the hopper and impede the process of emptying the hopper. At best this can require undoing the plug manually. At worse it can damage the ESP or bag and perhaps cause environmental problems.

It is an object of the invention to devise an apparatus and process for removing particulates from ESP or fabric filter hoppers in a manner that reduces the likelihood of hoppers overfilling or having the particulates cause plugs within the hoppers.

### SUMMARY OF THE INVENTION

The above and other objects are achieved by the apparatus and process of the present system in which there is no predetermined discharge time for the hoppers. The hoppers are kept open to feed, for example, fly ash continuously into an air activated gravity conveyor system which carries the fly ash into a conveyor such as screw pump line charger from which the fly ash is injected into a pressurized convey pipeline which transports the material to storage or a disposal site.

It is a feature of the present invention that the air activated gravity conveyor system utilized in the present invention is, in the aggregate, sized to convey the particulate material collected by a plant's ESP or baghouse at a rate at least about three times, and preferably between from about three times to about six times, and most preferably between from about three times to about five times, the rate that such particulate material is produced by the plant.

### BRIEF DESCRIPTION OF THE DRAWINGS

The invention will be described in connection with the annexed drawings wherein:

FIG. 1 is a side view partially in cutaway depicting a pair of adjacent fly ash hoppers, labeled 1 and 2.

FIG. 2 is a second view showing the same hoppers depicted FIG. 1 at a later period in time.

Similar numerals are utilized in the drawings to designate similar components. The figures are not necessarily drawn to scale.

### DETAILED DESCRIPTION OF THE INVENTION

This invention will be described in detail in the context of a fly ash removal process in a power plant.

Flue gas exiting a boiler in a power plant passes to a compartment containing an ash disengagement system that typically comprises one or more ESPs or fabric filter bags. With reference, for example, to a plant that uses ESPs, an ESP in a power plant will empty into a plurality of collection hoppers. While every plant requires its unique solution, a 600 MW generating unit may, for example, have an ESP which feeds into 48 hoppers, which may be arranged in six rows with eight hoppers in each row. A first row will be adjacent to gas inlet of the compartment and a last row will be adjacent to the gas outlet of the compartment. Hoppers closest to the gas inlet will tend to accumulate the largest amount of fly ash, with each succeeding row removing less fly ash. In a bag house the fabric filter bag compartments, and the underlying hoppers, are similarly arranged in a series of rows.

In prior art systems typically the ESPs or fabric bags are emptied sequentially. The underlying hoppers will empty hopper by hopper generally at predetermined time periods or when they reach a certain capacity, as determined by level switches or similar sensing devices. The emptying of the hoppers may not necessarily always be in sync with the emptying of the ESPs or hoppers from which they are fed fly ash.

In the present invention there is no change from prior art methods of how the ESPs or fabric bags are still emptied, however the present invention differs from standard prior art methods in that the underlying hoppers empty continuously into an adjacent air activated gravity conveyor, with a hopper displaying the heaviest flow of particulate matter into the air activated gravity conveyor at the same time that its associated ESP or fabric bag is hammered or pulsed cleaned.

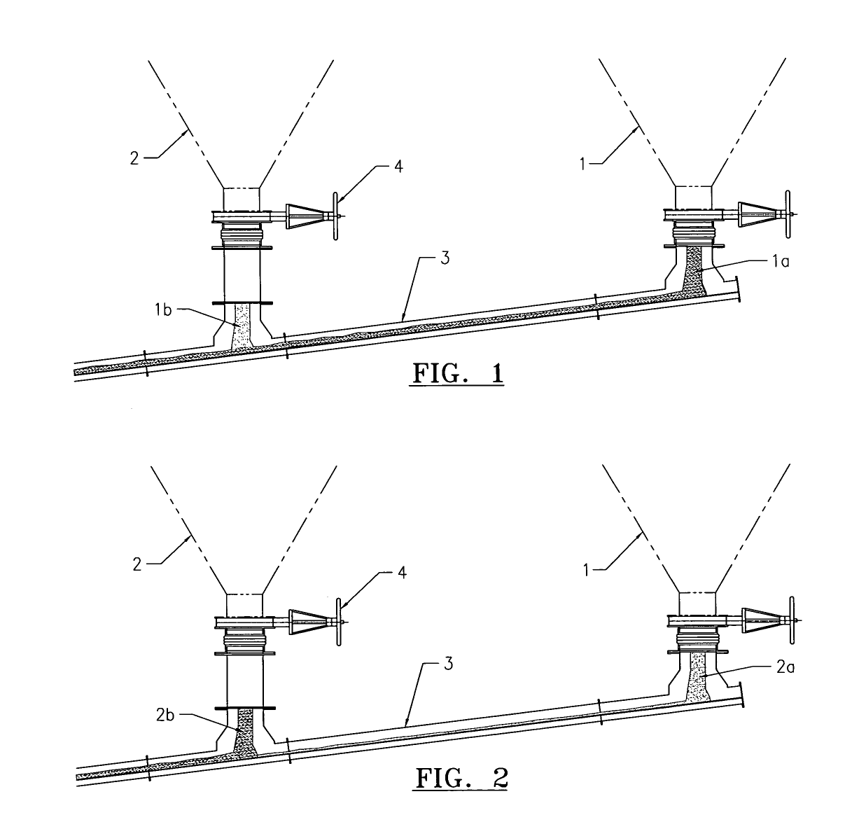

FIG. 2 is a side view partially in cutaway depicting a pair of adjacent fly ash hoppers, numbered 1 and 2. For the purposes of the illustration it does not matter whether the particular hoppers depicted are fed fly ash from an ESP or a fabric filter bag. Hopper 1 is example of a hopper being in the first row of hoppers closest to a gas inlet of a boiler. Hopper 2 is an example of a hopper being in a second row of hoppers. FIG. 1 depicts a condition at the time that the ESP or filter bag (not shown) associated with hopper 1 is being emptied. FIG. 2 depicts a condition directly after the events depicted in FIG. 1, when the ESP or filter bag associated with hopper 2 is emptied.

Hoppers 1 and 2 discharge fly ash into conventional air activated gravity conveyor 3. Air activated gravity conveyors are well known in the art and comprise a gas-permeable medium over which the material to be conveyed is adapted to flow. Immediately below the gas-permeable medium there is situated a plenum chamber through which air passes upwardly through the gas-permeable medium into the material. This aeration of the material fluidizes it and causes it to take on pseudo-liquid properties so that it will flow by gravity along the upper surface of the gas-permeable surface. Air activated gravity conveying systems are well known in the art and include FLSmidth's Airslide™ air activated gravity conveying system.

Typically conveying systems in traditional fly ash or other particulate removal systems that air feed from a particulate collector such as an ESP or baghouse are sized according to the particulate production rate of the plant. In a power plant the amount of fly ash produced will be dependant on the rate of coal utilization and the grade of coal being utilized. It is a feature of the present invention that the air activated gravity conveyor system utilized in the present invention is significantly oversized compared to the particulate production rate of the plant. The air activated gravity conveyor system is designed to carry the particulates collected in the hoppers to the conveying apparatus at a minimum rate, in the aggregate, of at least about 300% of the expected rate of accumulation in the hoppers, or a minimum of at least three times the normal fly ash creation rate of the plant, in a manner that there will be no accumulation of ash in the hoppers under normal or unusual operating conditions, and such that all hoppers will remain substantially empty during all operating conditions. Therefore, in the example set forth above in which a power plant produces 800 tons of fly ash a day (or 33⅓ tons per hour when operating 24 hours/day), the air activated gravity conveying system will be sized to remove at least 100 tons of fly ash per hour.

Preferably, the air activated gravity conveyor system utilized in the present invention is, in the aggregate, sized to convey the fly ash at a rate of between from about three times to about six times, and most preferably between from about three times to about five times, the rate that particulate material removed by a ESP or baghouse system is produced by a plant.

It is also a feature of the particulate removal system of the present invention that a standard valve adaptable to being automatically opened and closed is not a necessary component of the hopper. Rather gate 4 can be utilized to manually close the hopper for safety purposes when maintenance work is needed on the system. While the system is in operation gate 4 will always open permitted constant flow from of material from the hopper.

Referring again to FIG. 1, the flow 1 a of fly ash into air activated gravity conveying line 3 will be particularly heavy because the ESP or fabric filter immediate above hopper 1 is being emptied, and fly ash will flow directly through hopper 1 into conveying line 3. At the same time there is a light flow 1b of fly ash from hopper 2 into conveying line 3. This represents a light flow of fly ash from the ESP or fabric filter into hopper 2, fly ash that in conventional systems might reside in the hopper for several hours and consequently can plug the hopper. In the present system fly ash does not reside in a hopper for any substantial period.

FIG. 2 represents the time period directly after the period in which the ESP or fabric bag above hopper 1 has been emptied. FIG. 2 depicts the condition when an ESP or fabric bag is emptied into hopper 2 and therefore the flow 2b of material from hopper 2 into air activated gravity conveying line 3 is particularly heavy. Since the ESP or bag feeding into hopper 1 was just previously emptied, there will be substantially lighter flow 2a of material from hopper 1 into air activated gravity conveying line 3.

Air activated gravity conveyors 3 are typically arranged in a network, consisting of one entry point into the conveyor for each hopper of an electrostatic precipitator, bag house or other dust collector. Air activated gravity conveyors 3 use the fluidization principle to transport fly ash collected in the mentioned hoppers to a conveying apparatus, in a continuous manner during normal and unusual operating conditions of higher than normal material production rate.

Air activated gravity conveyors 3 transport the material to an apparatus such as, but not limited to, a rotary airlock, screw pump, pressure tank, vacuum pickup, or other such pneumatic transfer system; or a belt conveyor, screw conveyor, or other such mechanical transfer system from which the material is conveyed to a storage or disposal means. The preferred conveying apparatus is a screw pump that permits continuous operation. Such pumps act as a screw type volumetric line charger that use a material seal and can introduce material into a pressure conveying system. An example of suitable commercially available screw pumps is FLSmidth's Fuller-Kinyon™ pump. Preferably the conveying apparatus will be sized to handle at least 200% of the ash flow production rate.

Typically, the air activated gravity conveyor network will converge the fly ash to a common flow valve that feeds into the conveying apparatus. Optionally two conveying apparatuses can be employed with one apparatus acting in a standby capacity. A manual cutoff gate valve may be deployed at the inlet of each conveying device to select or isolate a device as desired. The rotary flow control valve will meter the fly ash into the inlet of the conveying device at a controlled rate for optimum ash conveyance under unusual conditions.

The present method is advantageous in that the equipment cost is less than a standard system, as, for example, cycling sequencing valves for the hoppers are not needed, and the overall control system does not have to be as extensive as in the prior art system that utilized vacuum or pressure conveying systems from the point of entry of the fly ash into the hoppers. The present system also replaces expensive vacuum or pressure systems located at the material outlet of each hopper with a comparatively low cost and low maintenance air activated gravity conveyor system.

A further advantage of the present system is that the continuous flow of ash from the hopper does not give the ash opportunity to come to rest and build up inside the hopper. Therefore conditions in which the ash will bridge over in the hopper and fail to flow when the sequential valve is closed are virtually eliminated.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for transporting particulate material produced by a plant, said material having been collected from the plant's exhaust gas stream by a particulate collection means having an exit for the particulate material that is flow connected to an underlying hopper; said method comprising
(i) directing particulate material from said particulate collection means into said hopper;
(ii) directing particulate material from said hopper into an air activated gravity conveyor system flow connected to said hopper, wherein said air activated gravity conveyor system is sized to convey particulate material at a rate that is at least about three times the rate that such particulate material is produced by the plant; and transporting said particulate material by said air activated gravity conveyor system to a conveying means from which it is transferred to an end location.

2. The method of claim 1 wherein said air activated gravity conveyor system is sized to convey particulate material at a rate that ranges from about three times to about six times the rate that such particulate material is produced by the plant.

3. The method of claim 2 wherein said air activated gravity conveyor system is sized to convey particulate material at a rate that ranges from about three times to about five times the rate that such particulate material is produced by the plant.

4. The method of claim 1 wherein the conveying means is a screw pump that feeds the particulate material into a pneumatic conveying line.

5. The method of claim 1 wherein the conveying means is a mechanical conveying device.

6. The method of claim 1 wherein the conveying means is sized to convey particulate material at a rate that is at least about 200% of the rate that such particulate material is produced by the plant.

7. The method of claim 1 wherein the hoppers discharge particulate material continuously into the air activated gravity conveyor system.

8. The method of claim 1 wherein the particulate material is fly ash.

9. A method for transporting fly ash produced by a coal-burning boiler system, said fly ash having been collected from the system's flue gas stream by a particulate collection means having an exit for the fly ash flow connected to an underlying hopper; said method comprising directing fly ash that exits said particulate collection means into said hopper and thereafter continuously directing said fly ash from said hopper into an air activated gravity conveyor system flow connected to said hopper, wherein said fluidized air conveyor system is sized to convey fly ash at a rate that is at least about three times the rate that such fly ash is produced by the coal-burning boiler system; and transporting said fly ash by said air activated gravity conveyor system to a screw pump from which it is transferred to an end location, said screw pump being sized to convey fly ash at a rate that is at least about 200% of the rate that such fly ash is produced by the coal-burning system.

10. The method of claim 9 wherein said air activated gravity conveyor system is sized to convey fly ash at a rate that ranges from about three times to about six times the rate that fly ash is produced by the boiler system.

11. The method of claim 9 wherein said air activated gravity conveyor system is sized to convey fly ash at a rate that ranges from about three times to about five times the rate that such fly ash is produced by the boiler system.

12. A fly ash transport system for transporting fly ash produced by a coal-burning plant, said system comprising
(i) a particulate collection means for removing fly ash from the plant's flue gas stream and having an exit through which fly ash is discharged;
(ii) at least one hopper disposed to receive fly ash that is discharged from said particulate collection means, said at least one hopper having a fly ash outlet;
(iii) an air activated gravity conveyor system for conveying the fly ash, said conveyor system being disposed to receive fly ash from the fly ash outlet of said at least one hopper, wherein said air conveyor system is sized to convey fly ash at a rate that is at least about three times the rate that such fly ash is produced by the coal-burning plant; and
(iv) a conveying means for receiving the fly ash from the air activated gravity conveyor system and conveying it to an end point.

13. The transport system of claim 12 wherein said air activated gravity conveyor system is sized to convey fly ash at a rate that ranges from about three times to about six times the rate that such fly ash is produced by the plant.

14. The transport system of claim 13 wherein said air activated gravity conveyor system is sized to convey fly ash at a rate that ranges from about three times to about five times the rate that such fly ash is produced by the plant.

15. The transport system of claim 12 wherein the conveying means is a screw pump that feeds the fly ash into a pneumatic conveying line.

16. The transport system of claim 12 wherein the conveying means is a mechanical conveying device.

17. The transport system of claim 12 wherein the conveying means is sized to convey the fly ash at a rate that is at least about 200% of the rate that such fly ash is produced by the coal-burning plant

18. The transport system of claim 12 further comprising means to enable the fly ash to flow continuously from the collection means through said hopper and into the air activated gravity conveyor system.
